(19) United States
(12) Patent Application Publication
(10) Pub. No.: US 2010/0027260 A1
(43) Pub. Date: Feb. 4, 2010

(54) LIGHT EMITTING DIODE LAMP

(75) Inventor: Chia-Chi Liu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: LUSTROUS INTERNATIONAL TECHNOLOGY LTD., Taipei Country (TW)

(21) Appl. No.: 12/182,137

(22) Filed: Jul. 30, 2008

(51) Int. Cl. F21V 29/00; F21V 21/00

(52) U.S. Cl. 362/249.01; 362/373

(57) ABSTRACT

A light emitting diode lamp including a housing having at least one hole, a light bar, a heat dissipation device, and a shade is provided. The light bar is disposed inside the housing, and has a circuit substrate and a plurality of LEDs disposed thereon. The heat dissipation device includes a heat conducting pipe and a heat sink, where the heat conducting pipe is connected to the circuit substrate, and extends to the outside of the housing through the hole. The heat sink is disposed on the portion of the heat conducting pipe exposed outside the housing. The shade is disposed on the housing, and shades the heat dissipation device.

### BACKGROUND OF THE INVENTION

1. Field of the Invention

The present invention generally relates to a lamp, in particular, to a light emitting diode lamp.

2. Description of Related Art

Ever since Thomas Edison introduced incandescent light bulb, the world has been utilizing electricity for illumination, and brighter, more power-saving and longer lasting illumination device has heretofore been developed and employed, fluorescent lamp among them. Compare to incandescent light bulbs, fluorescent lamps possess the advantage of higher efficiency and lower working temperature. Nevertheless, utilizing toxic mercury raises the cost of disposal of fluorescent lamp, as well as the potential danger of leakage of mercury vapor.

In the past few decades, an even more energy-saving and environmentally friendly illumination technology has been brought to prominent—light emitting diode (LED). An LED mainly includes a chip of semiconducting material, which has a P-N junction formed by contacting a P-type semiconductor layer with an N-type semiconductor layer. Applying a voltage drives charge carriers—electrons in N-type semiconductor layer and holes in P-type semiconductor layer—into the P-N junction, and when an electron meets a hole, it falls into a lower energy level and releases energy in the form of a photon. LEDs are more efficient then incandescent bulbs; moreover, being solid state components, LEDs are difficult to damage with external shock. In addition, LEDs are also smaller, have longer life span, and are more environment-friendly for not using mercury.

As the development of semiconductor technology has soared in recent years, the power of LEDs has also increased dramatically. However, the higher the power, the more heat the LEDs produce. LED performance largely depends on the ambient temperature of the operating environment. Driving an LED in high ambient temperatures may result in overheating of the LED, eventually leading to inefficiency or even device failure. Thus, adequate heat dissipation device is essential for maintaining high efficiency and long life.

FIG. 1a illustrates a conventional LED lamp. Referring to FIG. 1a, LED lamp 100 includes a circuit substrate 105, a plurality of LEDs 110, and a base 107. The LEDs 110 are disposed on the circuit substrate 105, and the circuit substrate 105 is disposed on the base 107. The heat produced by the LEDs 110 is conducted to the base 107, which has a plurality of heat dissipation fins 106 that help dissipate the heat to the environment.

### SUMMARY OF THE INVENTION

Accordingly, the present invention is directed to a light emitting diode lamp having a better heat dissipation performance.

The present invention provides a light emitting diode lamp including a housing having at least one hole, a light bar, a heat dissipation device, and a shade. The light bar is disposed inside the housing, and has a circuit substrate and a plurality of LEDs disposed thereon. The heat dissipation device includes a heat conducting pipe and a heat sink, where the heat conducting pipe is connected to the circuit substrate, and extends to the outside of the housing through the hole. The heat sink is disposed on the portion of the heat conducting pipe exposed outside the housing. The shade is disposed on the housing, and shades the heat dissipation device.

According to an embodiment of the present invention, the heat conducting pipe is a metal bar.

According to an embodiment of the present invention, the heat conducting pipe is a heat pipe.

According to an embodiment of the present invention, the heat pipe is a capillary heat pipe or a Perkins tube.

According to an embodiment of the present invention, the heat sink includes a plurality of heat dissipation fins.

According to an embodiment of the present invention, the heat dissipation fins are disposed on two ends of the heat conducting pipe.

According to an embodiment of the present invention, the heat dissipation fins include a plurality of spike-shaped and/or a plurality of rod-shaped structure.

According to an embodiment of the present invention, a material of the heat sink comprises metal.

According to an embodiment of the present invention, each of the heat dissipation fins has an assembling hole, and the heat dissipation fins are disposed on the heat conducting pipe with the heat conducting pipe inserted through the assembling holes.

According to an embodiment of the present invention, the housing has a plurality of holes and a plurality of sidewalls, and the holes are disposed on the sidewalls.

According to an embodiment of the present invention, the housing has two holes respectively disposed on two of the sidewalls that are opposite, and two ends of the heat conducting pipe extend through the two holes, respectively.

According to an embodiment of the present invention, the housing has two holes disposed on one of the sidewalls, and the heat conducting pipe includes two extending portions respectively extending through the holes disposing on one of the sidewalls, and a U-shaped portion connecting the two extending portions inside the housing.

According to an embodiment of the present invention, the heat dissipation fins are disposed on two ends of the heat conducting pipe.

According to an embodiment of the present invention, the circuit substrate comprises a substrate, a circuit pattern, an electrode and a wire. The light emitting diodes and the circuit pattern are disposed on the substrate, the electrode is disposed on the circuit pattern, and the wire is electrically connected to the circuit pattern through the electrode.

According to an embodiment of the present invention, the heat conducting pipe has a fastening element fastened in the hole.

According to an embodiment of the present invention, the fastening element has a first groove fastening on the hole.

According to an embodiment of the present invention, the hole has a second groove for the fastening element to be fastened in.

According to an embodiment of the present invention, the light emitting diode lamp further includes a base, disposed between the housing and the circuit substrate and supporting the circuit substrate.

According to an embodiment of the present invention, the base has a furrow covered by the circuit substrate, and the heat conducting pipe is disposed in the furrow.

According to an embodiment of the present invention, the circuit substrate further comprises at least one first screw and at least one first fixing hole, the base further has at least one second screw, at least one first threaded hole, and at least one second fixing hole, the housing further has at least one second threaded hole, and the first screw fastens the circuit substrate on the base through the first threaded hole and the first fixing hole, while the second screw fastens the base on the housing through the second threaded hole and the second fixing hole.

According to an embodiment of the present invention, the light emitting diode lamp further comprises a metal plate, disposed between the circuit substrate and the base.

As described above, in the present invention, the shade shades the heat dissipation device and therefore reduces the effect of ambient interference, such as sun light and dust. Thus, the light emitting diode lamp has a preferable heat dissipation ability, and superior performance.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1a illustrates a conventional LED lamp.

FIG. 2A is a 3D view of an LED lamp according to the first embodiment of the present invention.

FIG. 2B is a cross-sectional view along line A-A in FIG. 2A.

FIG. 2C is a cross-sectional view along line B-B in FIG. 2A.

FIG. 2D illustrates another implementation of the heat sink shown in FIG. 2A.

FIG. 2E illustrates yet another implementation of the heat sink shown in FIG. 2A.

FIG. 3 is a cross-sectional view of a LED lamp according to another embodiment of the present invention.

FIG. 4 illustrates a LED lamp according to another embodiment of the present invention.

FIG. 5 is the bottom view of the LED lamp in FIG. 4.

FIG. 6 illustrates another implementation of housing and heat conducting pipe according to an embodiment of the present invention.

FIG. 7A illustrates the connection between the heat conducting pipe and the housing shown in FIG. 6.

FIG. 7B illustrates another implementation of the connection between the heat conducting pipe and the housing shown in FIG. 6.

FIG. 8 is a local cross-sectional view of an LED lamp according to another embodiment of the present invention.

FIG. 9 is illustrates dissembled LED lamp shown in FIG. 8.

FIG. 10 illustrates an LED lamp according to another embodiment of the present invention.

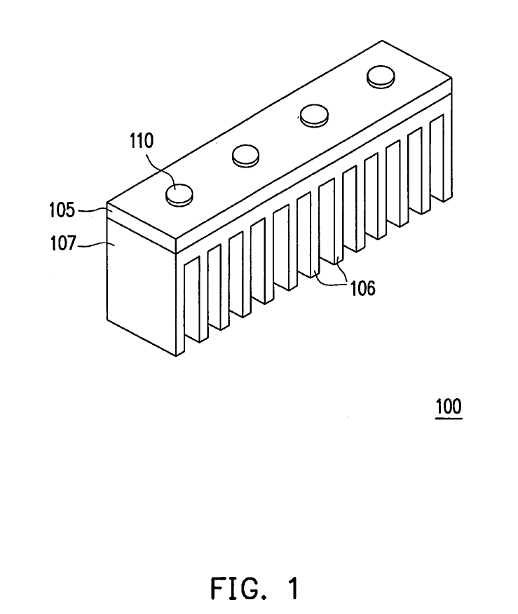

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

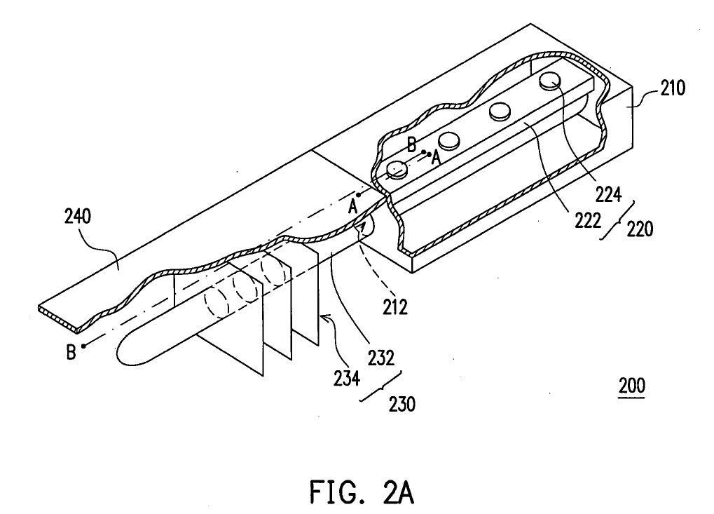

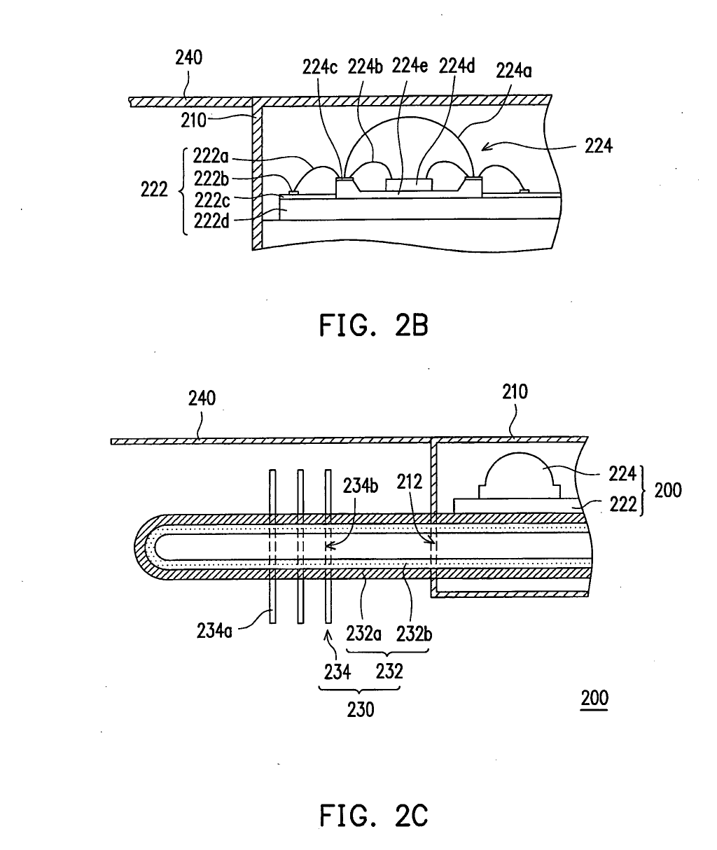

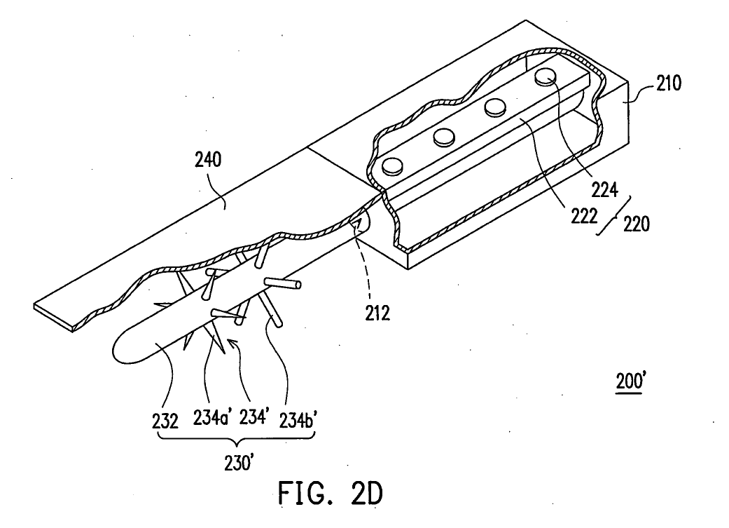

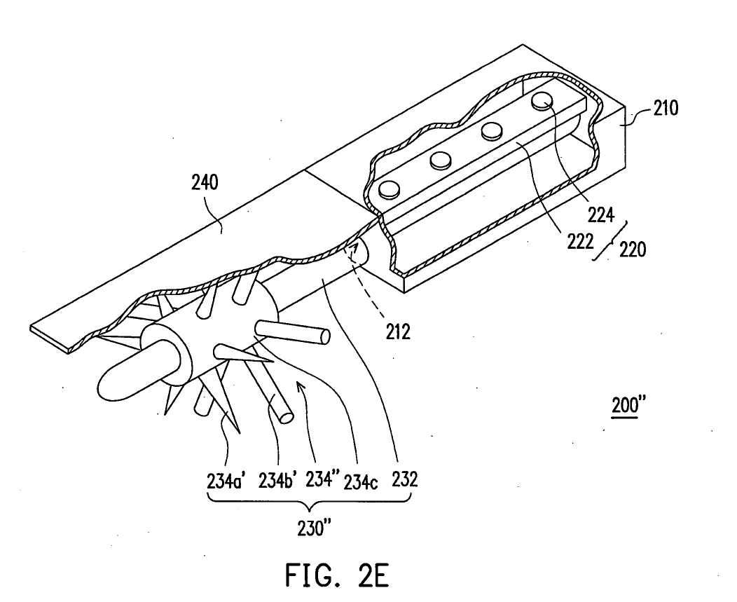

FIG. 2A is a 3D view of an LED lamp according to the first embodiment of the present invention. Referring to FIG. 2A, the LED lamp 200 includes a housing 210 having at least one hole 212, a light bar 220, a heat dissipation device 230, and a shade 240. The light bar 220 is disposed inside the housing 210, and has a circuit substrate 222 and a plurality of LED units 224 disposed thereon. The heat dissipation device 230 includes a heat conducting pipe 232 and a heat sink 234. The heat conducting pipe 232 is in contact with the circuit substrate 222 and extends to the outside of the housing 210 through the hole 212 and conducts the heat produced by the light bar 220 to the heat sink 234. The heat sink 234 is disposed on the portion of the heat conducting pipe 232 exposed outside the housing 210, and dissipates the heat conducted from the light bar 220 to the surrounding air. The shade 240 is disposed on the housing 210, and shades the heat dissipation device 230.

The shade 240 shades the heat dissipation device 230 so that the heat dissipation device 230 can be sheltered from ambient interference. For example, shade 240 may be disposed above the heat dissipation device 230, and thus works as a sunshade that block the sunlight, which prevents the heat dissipation device 230 from being heated, therefore increases the performance of the heat dissipation device 230. Moreover, the shade 240 can also reduce the amount of dust that accumulates on the heat dissipation device 230, which increases the contact between the heat dissipation device 230 and the surrounding air, and thus further enhances the performance of the heat dissipation device 230.

Besides, utilizing of heat conducting pipe 232 makes the disposition of the heat sink 234 more flexible, and therefore may decrease the thickness of the LED lamp 200, widens the usage of the LED lamp 200.

The heat conducting pipe 232 could be tightly assembled with the housing 210 through the hole 212 so that the light bar 220 inside the housing 210 can be well protected, which also keeps dust from entering the housing 210 and accumulating on the LED units 224, therefore prevents the decrease of brightness of the LED units 224.

The design of the housing 210 may vary according to usage. For example, the housing 210 may be made of transparent material, such as transparent acryl, glass, or transparent resin, which allows the light emitted by the LED units 224 to pass. The LED lamp 200 thus designed may be used as a ceiling light fixture. Otherwise, in an embodiment not illustrated, the housing may consist of only one transparent surface, and the other parts of the housing have reflective materials disposed inside and reflect the light emitted by the LED units. Thus designed LED lamp may be utilized as a low-divergence lighting device, such as flash light and spot light.

FIG. 2B is a cross-sectional view along line A-A in FIG. 2A. Referring to FIG. 2B, each of the LED units 224 includes a transparent resin 224a, a plurality of conducting wires 224b, a diode circuit pattern 224c, LED 224d and a metal set 224e. The LEDs 224d are disposed on the metal sets 224e. The metal set 224e, which may be made of aluminium, may reflect the light emitted by the LEDs 224d and enhances the brightness of the LED units 224.

The conducting wires 224b electrically connect between the LEDs 224d and the diode circuit patterns 224c, where the diode circuit patterns 224c may be made from copper foils or aluminium foils. The conducting wires 224b, diode circuit patterns 224c, and LEDs 224d are sealed with the transparent resin 224a which provides protection. Beside, the transparent resins 224a may have fluorescent material layer (not shown in the figure) disposed inside, which may be excited by the light emitted by the LEDs 224d and emit light with colors different from color of the light of the LEDs 224d.

The circuit substrate 222 includes a plurality of outer conducting wires 222a, a plurality of electrodes 222b, a substrate circuit pattern 222c, and a lamp substrate 222d. The LED units 224 are disposed on the lamp substrate 222d. The substrate circuit pattern 222c may be made of copper foil or aluminium foil and is disposed on the surface of the lamp substrate 222d; the electrodes 222b may be made of conductive material, and is disposed on the surface of the substrate circuit pattern 222c. The outer conducting wires 222a are electrically connected between the diode circuit pattern 224c and the electrodes 222b.

It is to be noticed that the LED units 224 and the circuit substrate 222 may be implemented in other ways, such as flip chip package and multi-LED package.

FIG. 2C is a cross-sectional view along line B-B in FIG. 2A. Referring to FIG. 2C, in the present embodiment, the heat sink 234 may include a plurality of heat dissipation fins 234a, which may be made of metal or other heat conductive materials. Each of the heat conducting fins 234a may have a assembling hole 234b, and the heat dissipation fins 234a are disposed on the heat conducting pipe 232 with the heat conducting pipe 232 inserted through the assembling holes 234b. The heat dissipation fins 234a may be assembled on the heat conducting pipe 232 by force fitting or welding.

Other than those disclosed above, the heat sink 234 may be implemented in various ways depends on different situations. FIG. 2D illustrates another implementation of the heat sink shown in FIG. 2A. Referring to FIG. 2D, heat sink 234′ in the heat dissipation device 230 may include a plurality of spike-shaped structures 234a′ and a plurality of rod-shaped structures 234b′, which may be radially disposed on the heat conducting pipe 232.

FIG. 2E illustrates yet another implementation of the heat sink shown in FIG. 2A. Referring to FIG. 2E, heat sink 234″ further has a sleeve 234c, on which the spike-shaped structures 234a′ and the rod-shaped structures 234b′ are disposed. The sleeve 234c maybe integrally formed with the spike-shaped structures 234a′ and the rod-shaped structures 234b′, therefore, the spike-shaped structures 234a′ and the rod-shaped structures 234b′ may be fastened on the heat conducting pipe 232 by putting the sleeve 234c through the heat conducting pipe 232 when assembling the heat sink 234″ with the heat conducting pipe 232, and thus simplifies the process of assembling the heat sink 234″ with the heat conducting pipe 232.

The heat conducting pipe 232 may be a metal bar or a heat pipe. For example, the heat conducting pipe 232 may be a capillary heat pipe or a Perkins tube. Referring to FIG. 2C, heat conducting pipe 232 includes a tube 232a, a capillary structure 232b, and coolant (not shown in the figure) where the coolant is disposed inside the capillary structure 232b and the capillary structure 232b is disposed inside the tube 232a.

The tube 232a may be made of heat conductive material, such as silver, copper or aluminium. The heat produced by the light bar 220 heats up the tube 232a inside the housing 210, and thus evaporates the coolant inside. The evaporated coolant diffuses to the portion of the tube 232a outside the housing 210 because of pressure difference, and then the heat carried by the coolant can be dissipated by the heat sink 234 and thus the coolant condenses. The condensed coolant is then moved back into the portion of the tube 232a inside the housing 210 by capillary structure 232b to evaporate again and repeat the cycle.

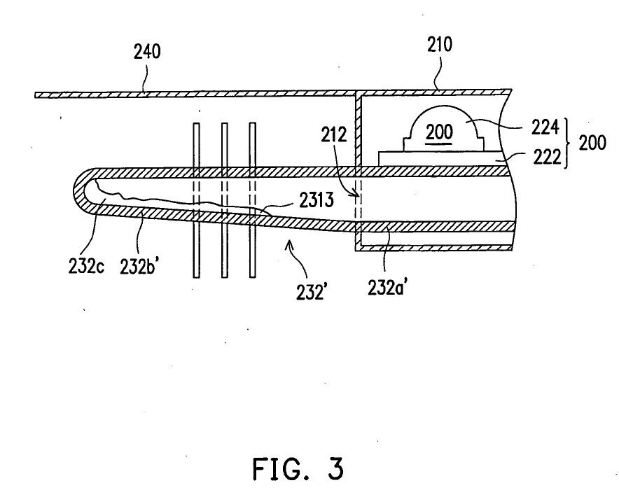

The heat conducting pipe can be implemented in other ways, Perkins tube among them. FIG. 3 is a cross-sectional view of a LED lamp according to another embodiment of the present invention. Referring to FIG. 3, heat conducting pipe 232′ includes a tube 232a′ with a slanted portion 232b′, and coolant 232c disposed inside the tube. Heat conducting pipe 232′ works similar to heat conducting pipe 232, but the coolant 232c condensed on the slanted portion 232b′ simply flows back to the portion of the tube 232a′ inside the housing 210 due to gravity.

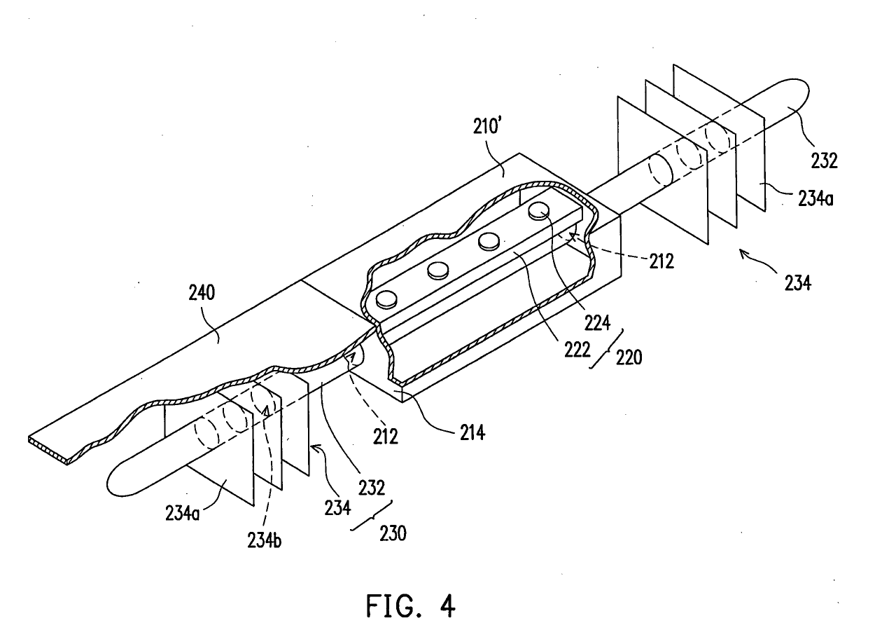

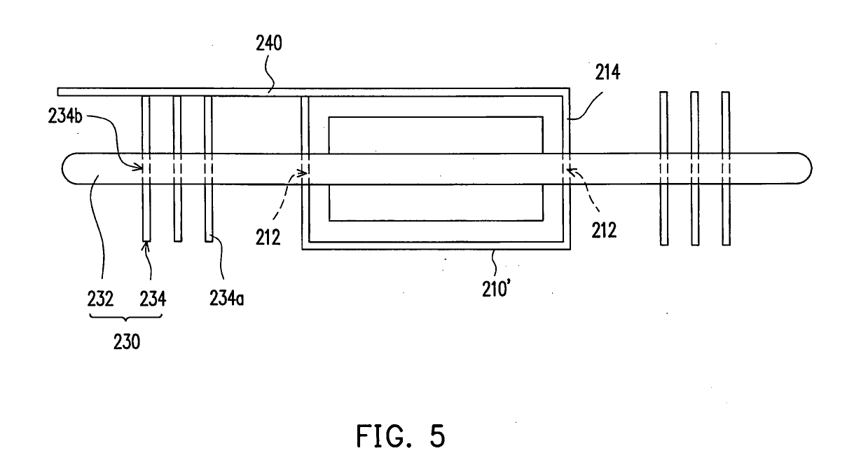

FIG. 4 illustrates a LED lamp according to another embodiment of the present invention, and FIG. 5 is the bottom view of the LED lamp in FIG. 4. It is to be noticed that the present embodiment is similar to the aforesaid embodiment shown in FIG. 2a, and in these two embodiments, like reference numerals refer to like elements. Referring to FIG. 4 and FIG. 5, housing 210′ has a plurality of holes 212 and a plurality of sidewalls 214, where the holes 212 are disposed on two of the sidewalls 214 that are opposite, respectively. The two ends of the heat conducting pipe 232 may extend through the two holes 212, respectively. The present embodiment may have a better heat dissipation performance, since the heat conducting pipe 232 has a greater contacting area.

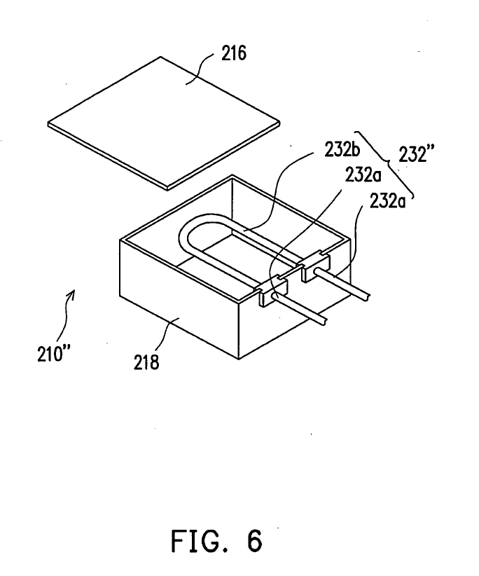

FIG. 6 illustrates another implementation of housing and heat conducting pipe according to an embodiment of the present invention. The housing 210″ has two holes 212 disposed on the same sidewall 214, and the heat conducting pipe 232 includes two extending portions 232a and a U-shaped portion 232b. The U-shaped portion connects the two extending portions inside the housing, while the extending portions extend through the holes respectively. In the present embodiment, the housing 210″ may includes an cover 216 and a box 218, where the cover 216 is assembled with the box 218 and thus fix the heat conducting pipe 232 in the holes 212.

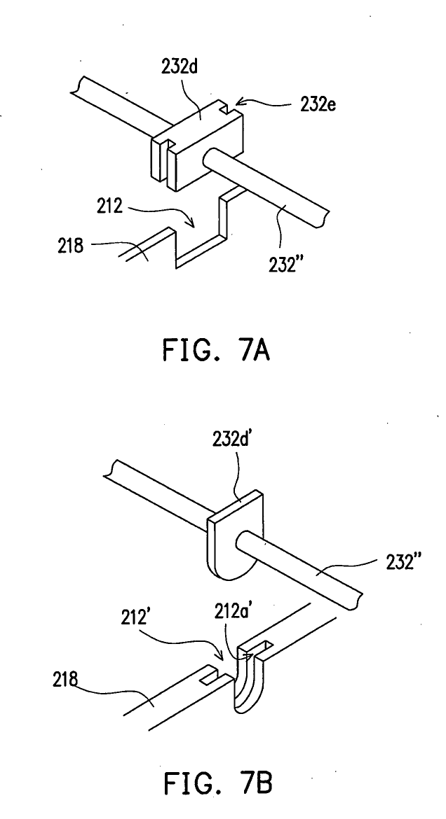

FIG. 7A illustrates the connection between the heat conducting pipe and the housing shown in FIG. 6. Referring to FIG. 7a, the heat conducting pipe 232″ has a fastening element 232d fastened in the hole 212. In the present embodiment, the holes 212 are rectangular-shaped, and the fastening element 232d may have a first groove 232e. The sides of the holes 212 fit in the groove 232e and thus fastened the fastening elements 232d on the holes 212.

FIG. 7B illustrates another implementation of the connection between the heat conducting pipe and the housing shown in FIG. 6. Referring to FIG. 7B, each of the holes 212 has a second groove 212a′, where the fastening elements 232d′ may fit in and thus fastens the heat conducting pipe 232 in the holes 212.

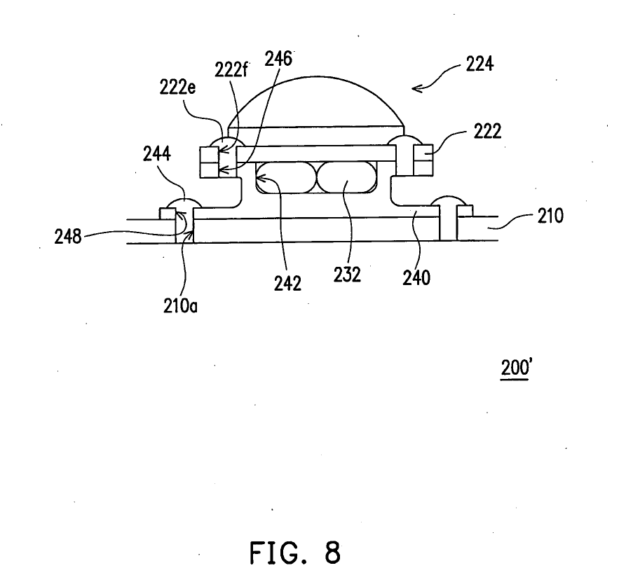

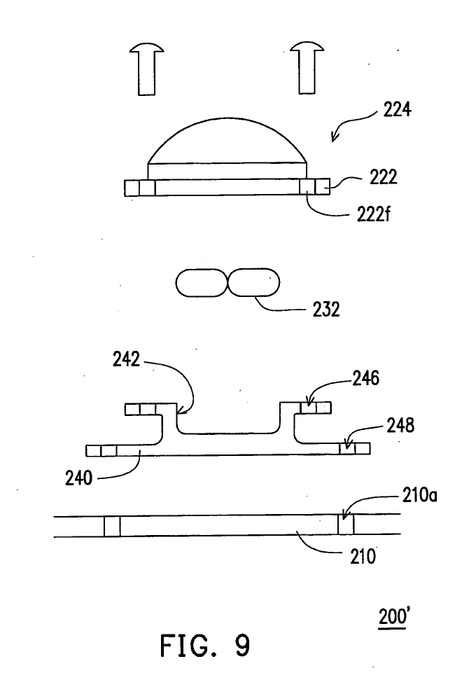

FIG. 8 is a local cross-sectional view of an LED lamp according to another embodiment of the present invention, FIG. 9 is illustrates dissembled LED lamp shown in FIG. 8. Referring to FIG. 8 and FIG. 9, LED lamp 200′ further includes a base 240 disposed between the housing 210 and the circuit substrate 222. The base 240 supports and fixes the circuit substrate 222. The base 240 has a furrow 242 for the heat conducting pipe 232 to be disposed in. The circuit substrate 222 may cover the furrow 242 so as to fix the heat conducting pipe 232 in the furrow 242. In the present embodiment, the furrow 242 may contain a plurality of heat conducting pipes 232. However, the furrow 242 can be designed otherwise, such as containing only one heat conducting pipe 232.

In the present embodiment, the circuit substrate 222 may further comprise at least one first screw 222e and at least one first fixing hole 222f, the base 240 may further have at least one second screw 244, at least one first threaded hole 246, and at least one second fixing hole 248, the housing 210 may further have at least one second threaded hole 210a, and the first screw 222e fastens the circuit substrate 222 on the base 240 through the first threaded hole 246 and the first fixing hole 222f, while the second screw 244 fastens the base 240 on the housing 210 through the second threaded hole 210a and the second fixing hole 248.

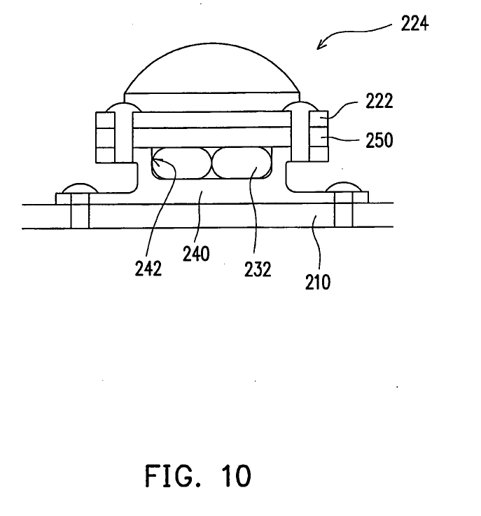

In the embodiment stated above, the heat conducting pipe is in direct contact with the circuit substrate, nonetheless, the heat conducting pipe can be in contact with the circuit substrate via other means. FIG. 10 illustrates an LED lamp according to another embodiment of the present invention. Referring to FIG. 10, the LED lamp further includes a metal plate 250, which is disposed between the circuit substrate 222 and the base 240. The metal plate 250 helps conducting the heat from the heat conducting pipe 232 to the base 240, thus enhances the heat dissipation performance.

In summary, the stated embodiment has a shade; the shade shades the heat dissipation device so that the heat dissipation device can be sheltered from ambient interference such as direct exposure to sunlight and accumulating of dust, therefore increases the efficiency of the heat dissipation device and the performance of the LED lamp.

Besides, utilizing of heat conducting pipe makes the disposition of the heat sink more flexible, and therefore may decrease the thickness of the LED lamp, widens the usage of the LED lamp.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light emitting diode lamp, comprising:
a housing, having at least one hole;
a light bar, disposed in the housing, comprising:
a circuit substrate;
a plurality, of light emitting diode units, disposed on the circuit substrate;
a heat dissipation device, comprising:
a heat conducting pipe, connected to the circuit substrate, and extends to the outside of the housing through the hole;
a heat sink, disposed on the portion of the heat conducting pipe exposed outside the housing; and
a shade, disposed on the housing, and shades the heat dissipation device.

2. The light emitting diode lamp according to claim 1, wherein the heat conducting pipe is a metal bar.

3. The light emitting diode lamp according to claim 1, wherein the heat conducting pipe is a heat pipe.

4. The light emitting diode lamp according to claim 3, wherein the heat pipe is a capillary heat pipe or a Perkins tube.

5. The light emitting diode lamp according to claim 1, wherein the heat sink includes a plurality of heat dissipation fins.

6. The light emitting diode lamp according to claim 5, wherein the heat dissipation fins are disposed on the ends of the heat conducting pipe.

7. The light emitting diode lamp according to claim 5, wherein the heat dissipation fins include a plurality of spike-shaped and/or a plurality of rod-shaped structure.

8. The light emitting diode lamp according to claim 5, wherein a material of the heat sink comprises metal.

9. The light emitting diode lamp according to claim 8, wherein each of the heat dissipation fins has an assembling hole, and the heat dissipation fins are disposed on the heat conducting pipe with the heat conducting pipe inserted through the assembling holes.

10. The light emitting diode lamp according to claim 1, wherein the housing has a plurality of sidewalls and a plurality of holes, and the holes are disposed on the sidewalls.

11. The light emitting diode lamp according to claim 10, wherein the housing has two holes respectively disposed on two of the sidewalls that are opposite, and two ends of the heat conducting pipe extend through the two holes, respectively.

12. The light emitting diode lamp according to claim 10, wherein the housing has two holes disposed on one of the sidewalls, and the heat conducting pipe comprises:
two extending portions, respectively extending through the holes disposing on one of the sidewalls; and
a U-shaped portion connecting the two extending portions inside the housing.

13. The light emitting diode lamp according to claim 10, wherein the heat dissipation fins are disposed on two ends of the heat conducting pipe.

14. The light emitting diode lamp according to claim 1, wherein the circuit substrate comprises:
a substrate, having the light emitting diodes disposed thereon;
a circuit pattern, disposed on the substrate;
an electrode, disposed on the circuit pattern; and
a wire, electrically connected to the circuit pattern through the electrode.

15. The light emitting diode lamp according to claim 1, wherein the heat conducting pipe has a fastening element fastened in the hole.

16. The light emitting diode lamp according to claim 15, wherein the fastening element has a first groove, fastening on the hole.

17. The light emitting diode lamp according to claim 15, wherein the hole has a second groove, for the fastening element to be fastened in.

18. The light emitting diode lamp according to claim 1, further comprising a base, disposed between the housing and the circuit substrate and supporting the circuit substrate.

19. The light emitting diode lamp according to claim 18, wherein the base has a furrow covered by the circuit substrate, and the heat conducting pipe is disposed in the furrow.

20. The light emitting diode lamp according to claim 18, wherein the circuit substrate further comprises at least one first screw and at least one first fixing hole, the base further has at least one second screw, at least one first threaded hole, and at least one second fixing hole, the housing further has at least one second threaded hole, and the first screw fastens the circuit substrate on the base through the first threaded hole and the first fixing hole, while the second screw fastens the base on the housing through the second threaded hole and the second fixing hole.

21. The light emitting diode lamp according to claim 18, further comprising a metal plate, disposed between the circuit substrate and the base.
